(19) United States
(12) Patent Application Publication
(10) Pub. No.: US 2022/0001851 A1
(43) Pub. Date: Jan. 6, 2022

(54) Internal Combustion Engine Control Device

(71) Applicant: Hitachi Astemo, Ltd., Hitachinaka-shi, Ibaraki (JP)

(72) Inventors: Shogo NAMBA, Hitachinaka-shi (JP); Masayuki SARUWATARI, Hitachinaka-shi (JP)

(21) Appl. No.: 17/289,909

(22) PCT Filed: Sep. 12, 2019
(86) PCT No.: PCT/JP2019/035832

§ 371 Date: Apr. 29, 2021

(30) Foreign Application Priority Data
Nov. 6, 2018 (JP) 2018-208729

(51) Int. Cl. B60W 20/16; F02D 15/02; F02D 41/02; F02D 41/06; F02D 13/02; F01N 3/20; B60W 10/06

(52) U.S. Cl. CPC B60W 20/16; F02D 15/02; F02D 41/024; F02D 41/068; B60W 10/08; F01N 3/2006; B60W 10/06; F02D 2200/0804; F02D 2200/50; F02D 13/0215

(57) ABSTRACT

Provided is an internal combustion engine control device capable of maintaining an activation temperature of a catalyst while suppressing deterioration of an exhaust gas in a hybrid engine. To this end, the internal combustion engine control device of the present invention controls an internal combustion engine in an engine for a hybrid vehicle. The internal combustion engine has a catalyst that purifies the harmful substances in the exhaust gas and a catalyst temperature detection unit that detects the temperature of the catalyst. Then, when the temperature of the catalyst detected by the catalyst temperature detection unit does not reach a predetermined temperature, the internal combustion engine control device performs a catalyst temperature rise control for increasing the temperature of the catalyst and performs motoring.

### TECHNICAL FIELD

The present invention relates to an internal combustion engine control device.

### BACKGROUND ART

An engine for a hybrid vehicle powered by an internal combustion engine (hereinafter, referred to as a hybrid engine) is widely known as a means of an engine configuration for suppressing air pollution. In general, the hybrid engine uses a catalyst to purify an exhaust gas of the engine, like an existing automobile engine that does not have a battery for traveling (hereinafter, referred to as an existing engine).

The hybrid engine is characterized in that a frequency of use of the engine is lower than that of the existing engine because electric power assist by the battery for traveling is attached. In particular, in a scene where stop and go are repeated, such as city traveling, a time of traveling by the battery (hereinafter, referred to as battery traveling) becomes long, and thus, a stop time of the engine tends to be long. Therefore, the hybrid engine often has advantages in fuel efficiency and exhaust as compared with the existing engine.

Meanwhile, since the engine stop time of the hybrid engine is longer than that of the existing engine, a temperature of a three-way catalyst existing on a downstream side of an engine system during traveling (hereinafter, referred to as a catalyst temperature) tends to decrease. Catalyst activation of the three-way catalyst largely depends on the catalyst temperature, and when the catalyst temperature falls below a certain reference value, a purification rate of hydrocarbons, nitrogen oxides, carbon monoxide, or the like decreases, and the overall exhaust performance of the engine system decreases.

In order to suppress the decrease in the catalyst temperature, for example, it is conceivable to estimate the catalyst temperature and implement control to start the engine when the catalyst temperature falls below the reference value. However, in this case, it is necessary to start the engine frequently depending on temperature condition of outside air and an ON/OFF condition of an air conditioner, and as a result, there is a problem that the exhaust performance cannot be improved.

As a means for solving the problem, for example, PTL 1 is described. In a hybrid engine described in PTL 1, a throttle valve is closed and an EGR valve is opened while the engine is motorized by a motor generator powered by a battery at the time of starting or before starting the engine, and a catalyst is heated by a heater installed on an upstream side of the catalyst. Then, air heated by the heater is returned to an intake pipe through an EGR pipe, compressed by an internal combustion engine, and then passes through a return path for warming the catalyst again, and thus, catalyst warm-up is effectively performed.

Further, PTL 2 discloses a control method of, in a hybrid diesel engine, closing intake and exhaust valves to perform motoring of the engine, and warming up the engine by compression of an air-fuel mixture and generation of frictional heat caused by sliding of a piston.

### CITATION LIST

### Patent Literature

PTL 1: JP 2011-011647 A

PTL 2: JP 2004-324442 A

### SUMMARY OF INVENTION

### Technical Problem

However, in the invention described in PTL 1, it is necessary to provide a heater on an upstream side of a catalyst, which increases the number of components. Further, in the control method disclosed in PTL 2, since the intake and exhaust valves are fully closed, energy of exhaust heat is not supplied to the catalyst. Therefore, the engine is started while a catalyst temperature is lowered, and thus, it takes time for the catalyst to reach an activation temperature. In addition, an exhaust gas of the engine is discharged to the outside air until the catalyst reaches the activation temperature, which causes air pollution.

An object of the present invention is to provide an internal combustion engine control device capable of maintaining the activation temperature of the catalyst while suppressing deterioration of the exhaust gas in a hybrid engine in consideration of the problems.

### Solution to Problem

In order to solve the above problems and achieve the object of the present invention, an internal combustion engine control device of the present invention controls an internal combustion engine in an engine for a hybrid vehicle. The internal combustion engine has a catalyst that purifies harmful substances in an exhaust gas. Then, the internal combustion engine control device includes a catalyst temperature detection unit that detects a temperature of the catalyst, and a control unit that performs a catalyst temperature rise control for increasing the temperature of the catalyst and performs motoring when the temperature of the catalyst detected by the catalyst temperature detection unit does not reach a predetermined temperature.

### Advantageous Effects of Invention

According to the internal combustion engine control device having the above configuration, it is possible to maintain an activation temperature of the catalyst while suppressing deterioration of an exhaust gas.

Objects, configurations, and effects other than those described above will be clarified by the following descriptions of embodiments.

### BRIEF DESCRIPTION OF DRAWINGS

FIG. 1 is a schematic configuration diagram illustrating a configuration example of a vehicle having a hybrid engine according to a first embodiment of the present invention.

FIG. 2 is a schematic configuration diagram illustrating an internal combustion engine and an internal combustion engine control device (ECU) according to the first embodiment of the present invention.

FIG. 3 is a diagram illustrating an intake/exhaust valve profile of an internal combustion engine having a variable valve mechanism of an intake valve and an exhaust valve.

FIG. 4 is a diagram illustrating a catalyst temperature estimation calculation unit in the internal combustion engine control device (ECU) according to the first embodiment of the present invention.

FIG. 5 is a flowchart illustrating activation temperature processing of a catalyst by the internal combustion engine control device (ECU) according to the first embodiment of the present invention.

FIG. 6 is a diagram illustrating a change in a state quantity of an internal combustion engine due to a catalyst temperature rise control according to the first embodiment of the present invention.

FIG. 7 is a diagram illustrating a change in a state quantity of an internal combustion engine due to a catalyst temperature rise control according to a second embodiment of the present invention.

FIG. 8 is a diagram illustrating a change in a state quantity of an internal combustion engine due to a catalyst temperature rise control according to a third embodiment of the present invention.

FIG. 9 is a diagram illustrating a change in a state quantity of an internal combustion engine due to a catalyst temperature rise control according to a fourth embodiment of the present invention.

### DESCRIPTION OF EMBODIMENTS

### 1. First Embodiment

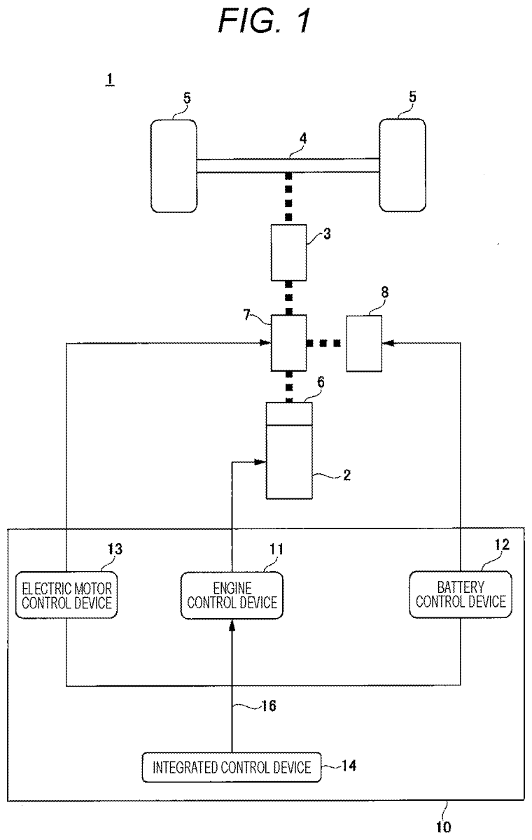

Hereinafter, an internal combustion engine control device according to a first embodiment of the present invention will be described with reference to FIGS. 1 to 6. Common members in each drawing are represented by the same reference numerals.

### [Vehicle Configuration]

First, a configuration example of a vehicle having a hybrid engine according to the first embodiment will be described with reference to FIG. 1.

FIG. 1 is a schematic configuration diagram illustrating the configuration example of the vehicle having the hybrid engine.

As illustrated in FIG. 1, a vehicle 1 is a vehicle of a hybrid system having an engine 2 illustrating an example of an internal combustion engine and a motor 3. As illustrated in FIG. 1, the vehicle 1 includes the engine 2, the motor 3, a shaft 4, a tire 5 connected to the shaft 4, a generator 6, an inverter 7, and a battery 8. Further, the vehicle 1 includes a vehicle control system 10.

The generator 6 is connected to a drive shaft of the engine 2. The engine 2 and the generator 6 constitute a generator that generates electric power. The electric power generated by the engine 2 and the generator 6 is supplied to the motor 3 or the battery 8. Accordingly, the battery 8 is charged.

The motor 3 is driven by electric power charged in the battery 8 or electric power generated by the engine 2 and the generator 6. When the motor 3 is driven, the tire 5 rotates via the shaft 4.

The vehicle 1 has a pattern in which the motor 3 is driven by the electric power stored in the battery 8 and the vehicle 1 travels, and a pattern in which the motor 3 is driven by the electric power generated by the engine 2 and the generator 6 and the vehicle 1 travels. Further, the vehicle 1 has a pattern in which the motor 3 is driven by the electric power of the battery 8 and the electric power generated by the engine 2 and the generator 6 and the vehicle 1 travels when a load is high.

Further, during deceleration, in the vehicle 1, electricity is generated by rotating the motor 3 and the inverter 7 by kinetic energy from the tire 5. Then, the electric power generated by the motor 3 and the inverter 7 is charged into the battery 8.

Further, the vehicle 1 has the vehicle control system 10 that controls the engine 2, the motor 3, the battery 8, or the like described above. The vehicle control system 10 includes an engine control device 11 illustrating a specific example of an internal combustion engine control device, a battery control device 12, an electric motor control device 13, and an integrated control device 14.

The engine control device 11, the battery control device 12, the electric motor control device 13, and the integrated control device 14 transmit and receive various information to and from each other via a communication line 16. As the communication line 16, for example, a multiplex communication line is used to form a network based on a Controller Area Network (CAN) protocol. The communication line 16 is not limited to the multiplex communication line.

The integrated control device 14 detects an operation of a driver and a state of the vehicle from information received from various sensors provided in the vehicle 1 or the engine control device 11, the battery control device 12, and the electric motor control device 13. Then, the integrated control device 14 determines a traveling pattern of the vehicle 1 and transmits control command data to the engine control device 11, the battery control device 12, and the electric motor control device 13.

The engine control device 11 which is an Engine Control Unit (ECU) controls the engine 2 which is an internal combustion engine based on the control command data transmitted from the integrated control device 14. Further, the engine control device 11 acquires various information from the engine 2 and outputs the information to the integrated control device 14 via the communication line.

The battery control device 12 acquires a State Of Charge (SOC), which is a remaining capacity of the battery 8. Hereinafter, this is simply referred to as SOC. Then, the battery control device 12 outputs the acquired SOC to the integrated control device 14 via the communication line 16.

The electric motor control device 13 controls drive of the motor 3 and the inverter 7 based on the control command data transmitted from the integrated control device 14. Further, the electric motor control device 13 acquires various information from the motor 3 and the inverter 7, and outputs the acquired information to the integrated control device 14 via the communication line 16.

For example, each of the integrated control device 14, the engine control device 11, the battery control device 12, and the electric motor control device 13 has a Central Processing Unit (CPU), a Random Access Memory (RAM), and a Read Only Memory (ROM). The RAM is used as a work area of the CPU, and the ROM stores programs or the like executed by the CPU.

### [Configuration of Internal Combustion Engine]

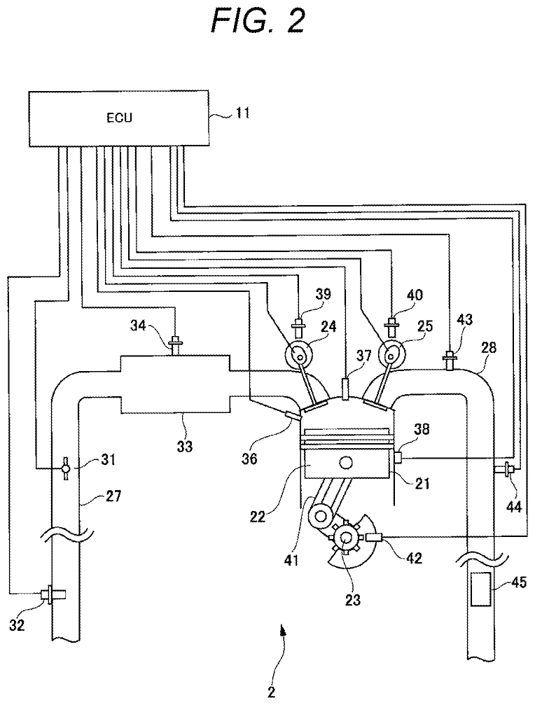

Next, a configuration of the engine 2 which is an internal combustion engine will be described with reference to FIG. 2.

FIG. 2 is a schematic configuration diagram illustrating the engine 2 and the engine control device 11.

The engine 2 illustrated in FIG. 2 is an in-cylinder injection type engine. The engine 2 is a four-cycle engine that repeats four strokes of an intake stroke, a compression stroke, a combustion (expansion) stroke, and an exhaust stroke, and for example, is a multi-cylinder engine having four cylinders. The number of cylinders of the engine 2 is not limited to four, and may have six or eight or more cylinders.

The engine 2 has a cylinder 21, a piston 22, a crankshaft 23, an intake valve 24, and an exhaust valve 25. An intake pipe 27 forming an intake flow path and an exhaust pipe 28 forming an exhaust flow path are communicated with the cylinder 21. A throttle valve 31, which narrows the intake flow path to control an amount of gas flowing into the cylinder 21, is provided in the intake pipe 27.

The throttle valve 31 is an electronically controlled throttle valve that can control a valve opening degree independently of an accelerator pedal depression amount. An airflow sensor 32 is attached to an upstream side of the throttle valve 31 in the intake pipe 27. The airflow sensor 32 detects a temperature and an amount of gas flowing into the intake pipe 27. Further, an intake manifold 33 is provided on a downstream side of the throttle valve 31 in the intake pipe 27. A temperature and pressure sensor 34 is assembled to the intake manifold 33.

A fuel injection device 36, a spark plug 37, and a water temperature sensor 38 are provided in the cylinder 21. The fuel injection device 36 is connected to a fuel tank (not illustrated) in which a fuel is stored via a fuel supply pipe and a common rail, and injects the fuel into the cylinder 21. The spark plug 37 exposes an electrode portion in the cylinder and ignites a combustible air-fuel mixture by sparking. The water temperature sensor 38 measures a temperature of cooling water that cools the cylinder 21.

The intake valve 24 is disposed to be openable and closable at an intake port of the cylinder 21, and the exhaust valve 25 is disposed to be openable and closable at an exhaust port of the cylinder 21. In the present embodiment, a variable valve mechanism that continuously changes opening/closing phases of the intake valve 24 and the exhaust valve 25 is adopted, and has an intake-side camshaft and an exhaust-side camshaft.

When the intake-side camshaft rotates, the intake valve 24 is driven to open or close the intake port of the cylinder 21. An intake valve sensor 39 for detecting the opening/closing phase of the intake valve 24 is attached to the intake valve 24. Further, when the exhaust-side camshaft rotates, the exhaust valve 25 is driven to open or close the exhaust port of the cylinder 21. An exhaust valve sensor 40 for detecting the opening/closing phase of the exhaust valve 25 is attached to the exhaust valve 25.

The piston 22 reciprocates in the cylinder 21 due to a combustion pressure. The crankshaft 23 is connected to the piston 22 via a connecting rod 41. Then, a reciprocating motion of the piston 22 is converted into a rotary motion by the crankshaft 23.

A crank angle sensor 42 is attached to the crankshaft 23. The crank angle sensor 42 detects a rotation and a phase of the crankshaft 23, and outputs a detection result to the engine control device 11. The engine control device 11 can detect a rotation speed of the engine (internal combustion engine) 2 based on the output of the crank angle sensor 42.

A temperature and pressure sensor 43 that detects a temperature and a pressure of an exhaust gas is attached to the exhaust pipe 28. An air-fuel ratio sensor 44 is provided on a downstream side of the temperature and pressure sensor 43 in the exhaust pipe 28. The air-fuel ratio sensor 44 detects an oxygen concentration contained in the exhaust gas and outputs a detection result to the engine control device 11. The engine control device 11 performs feedback control based on the detection result of the air-fuel ratio sensor 44 so that a fuel injection amount supplied from the fuel injection device 36 becomes a target air-fuel ratio.

A three-way catalyst 45 is provided on a downstream side of the air-fuel ratio sensor 44 in the exhaust pipe 28. The three-way catalyst 45 purifies harmful substances such as nitrogen oxides (NOx) contained in the exhaust gas.

Various sensors such as the airflow sensor 32, the temperature and pressure sensor 34, the water temperature sensor 38, the intake valve sensor 39, the exhaust valve sensor 40, the crank angle sensor 42, the temperature and pressure sensor 43, and the air-fuel ratio sensor 44 described above are connected to the engine control device (ECU) 11. Further, various actuators such as the intake valve 24, the exhaust valve 25, the throttle valve 31, the fuel injection device 36, and the spark plug 37 are connected to the engine control device 11.

The engine control device 11 outputs a control signal to actuators such as the throttle valve 31, the fuel injection device 36, and the intake/exhaust valves 24 and 25 with variable mechanisms to control the drive of various actuators. Further, the engine control device 11 detects an operating state of the engine (internal combustion engine) 2 based on the detection results (signals) supplied from the various sensors described above.

Further, the engine control device 11 determines a timing of ignition performed by the spark plug 37 according to the operating state of the engine (internal combustion engine) 2. Here, the control signal output from the engine control device 11 to the fuel injection device 36 is referred to as an injection pulse signal, and the control signal output to the spark plug 37 is referred to as an ignition signal.

### [Operation of Variable Valve Mechanism]

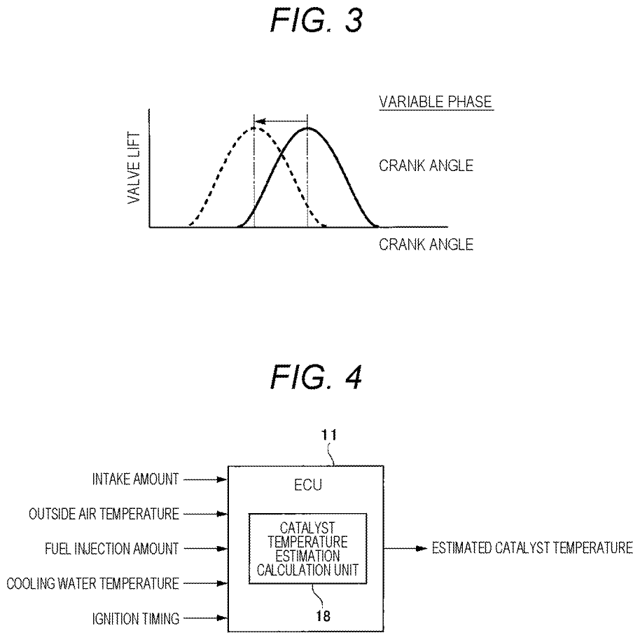

Next, an operation of the variable valve mechanism will be described with reference to FIG. 3.

FIG. 3 is a diagram illustrating an intake/exhaust valve profile of the internal combustion engine having the variable valve mechanism of the intake valve 24 and the exhaust valve 25.

As described above, the present embodiment adopts a variable phase type variable valve mechanism. As illustrated in FIG. 3, in the variable phase type variable valve mechanism, only the phase can be changed while a valve opening period (hereinafter, referred to as a valve operation angle) is constant. A portion that controls the variable valve mechanism in the CPU of the engine control device 11 is a first specific example of a control unit according to the present invention.

### [Catalyst Temperature Detection Unit]

Next, the catalyst temperature detection unit will be described with reference to FIG. 4.

FIG. 4 is a diagram illustrating a catalyst temperature estimation calculation unit.

As illustrated in FIG. 4, the engine control device (ECU) 11 has a catalyst temperature estimation calculation unit 18 illustrating a specific example of the catalyst temperature detection unit. The catalyst temperature estimation calculation unit 18 performs a catalyst temperature estimation calculation based on an intake air amount which is an amount of a gas flowing in from the intake pipe 27, an outside air temperature, the fuel injection amount, a cooling water temperature, and an ignition timing of the spark plug 37 to calculate an estimated catalyst temperature.

The intake air amount and the outside air temperature are detected by the airflow sensor 32. The fuel injection amount is detected based on the injection pulse signal output to the fuel injection device 36. The cooling water temperature is detected by the water temperature sensor 38. In this way, when the estimated catalyst temperature is obtained by using the cooling water temperature or the like, the temperature of the catalyst can be detected without providing a special sensor or the like, and the number of parts can be reduced.

The catalyst temperature detection unit according to the present invention may be a catalyst temperature sensor that detects the temperature of the three-way catalyst 45. The catalyst temperature sensor is provided between an upstream and a downstream of the three-way catalyst 45, and a detection result of the catalyst temperature sensor is sent to the engine control device 11.

### [Activation Temperature Processing of Catalyst by Engine Control Device]

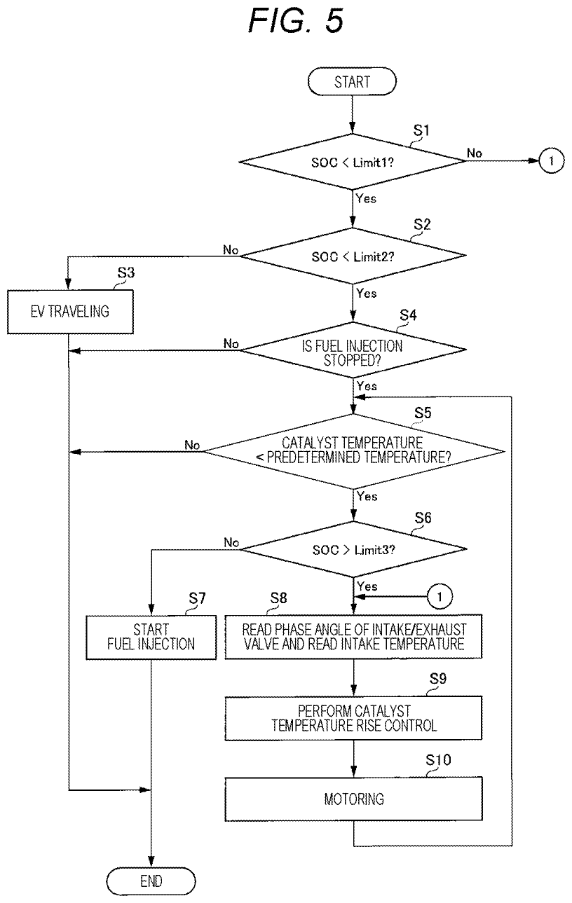

Next, activation temperature processing of the catalyst by the engine control device 11 will be described with reference to FIG. 5.

FIG. 5 is a flowchart illustrating the activation temperature processing of the catalyst by the internal combustion engine control device (ECU).

First, the engine control device 11 determines whether or not the remaining capacity (SOC) of the battery 8 is smaller than a Limit1 (S1). The Limit1 corresponds to a third threshold according to the present invention. The SOC of the battery 8 is supplied from the battery control device 12 to the engine control device 11 via the integrated control device 14. The SOC of the battery 8 may be supplied directly from the battery 8 to the engine control device 11.

The Limit1 (third threshold) indicates a threshold of the SOC when it is determined that the power of the battery 8 can be used for catalyst temperature rise control and motoring. For example, during deceleration, the motor 3 and the inverter are rotated due to the kinetic energy from the tire 5 to generate electricity. In this case, when the SOC of the battery 8 is sufficient, there will be surplus power, and thus, the catalyst temperature rise control or the motoring is performed by the surplus power, and it is possible to increase the temperature of the three-way catalyst 45.

When it is determined in S1 that the SOC of the battery 8 is the Limit1 or more (when the determination in S1 is NO), the engine control device 11 shifts the processing to S7. Meanwhile, when the SOC of the battery 8 is determined to be smaller than the Limit1 in S1 (when the determination in S1 is YES), the engine control device 11 determines whether or not the SOC of the battery 8 is smaller than a Limit2 (S2). The Limit2 corresponds to a second threshold according to the present invention.

When it is determined in S2 that the SOC of the battery 8 is the Limit2 or more (when the determination in S2 is NO), the engine control device 11 determines that EV travel is possible and executes the EV travel (S3). That is, the Limit2 (second threshold) indicates a threshold of the SOC when it is determined that the EV travel is possible. In the processing of S3, the engine control device 11 causes the engine 2 and the generator 6 not to generate electricity. Further, after the processing of S3, the engine control device 11 ends the activation temperature processing of the catalyst.

Meanwhile, when it is determined in S2 that the SOC of the battery 8 is smaller than the Limit2 (when the determination in S2 is YES), the engine control device 11 determines whether or not the fuel injection by the fuel injection device 36 is stopped (S4). In S4, when it is determined that the fuel injection by the fuel injection device 36 is not stopped (when the determination in S4 is NO), that is, when the engine 2 and the generator 6 are generating power, the engine control device 11 ends the activation temperature processing of the catalyst.

Meanwhile, in S4, when it is determined that the fuel injection by the fuel injection device 36 is stopped (when the determination in S4 is YES), the engine control device 11 determines whether or not the temperature (catalyst temperature) of the three-way catalyst 45 is lower than a predetermined temperature (S5).

As described above, the temperature (catalyst temperature) of the three-way catalyst 45 is calculated by the catalyst temperature estimation calculation unit 18 (refer to FIG. 4). In addition, the predetermined temperature is a temperature within a constant or variable range from a temperature at which the three-way catalyst 45 is activated and a purification rate of hydrocarbons, nitrogen oxides, carbon monoxide, or the like reaches a predetermined level (activation temperature).

When it is determined in S5 that the temperature (catalyst temperature) of the three-way catalyst 45 is the predetermined temperature or more (when the determination in S5 is NO), the engine control device 11 ends the activation temperature processing of the catalyst. That is, since the catalyst temperature has reached the temperature at which the three-way catalyst 45 is activated, the engine control device determines that it is not necessary to increase the temperature of the three-way catalyst 45.

Meanwhile, when it is determined in S5 that the temperature (catalyst temperature) of the three-way catalyst 45 is lower than the predetermined temperature (when the determination in S5 is YES), the engine control device 11 determines whether or not the SOC of the battery 8 is larger than a Limit3 (S6). That is, the engine control device 11 determines that it is necessary to increase the temperature of the three-way catalyst 45 because the catalyst temperature has not been reached the temperature at which the three-way catalyst 45 is activated. In addition, the Limit3 corresponds to a first threshold according to the present invention.

When it is determined in S6 that the SOC of the battery 8 is the Limit3 or less (when the determination in S6 is NO), the engine control device 11 starts the injection of the fuel by the fuel injection device 36 (S7). That is, in the processing of S7, the engine control device 11 causes the engine 2 and the generator 6 to generate electricity. After the processing of S7, the engine control device 11 ends the activation temperature processing of the catalyst.

The Limit3 (first threshold) indicates the threshold of the SOC when it is determined that the engine 2 and the generator 6 need to generate electricity. That is, when it is necessary to generate electricity with the engine 2 and the generator 6, the catalyst temperature rise control described below is not performed or stopped. Note that the Limit3 is smaller than the Limit2, and the Limit2 is smaller than the Limit1 (Limit3<Limit2<Limit1).

Meanwhile, when it is determined in S6 that the SOC of the battery 8 is larger than the Limit3 (when the determination in S6 is NO), or when it is determined in S1 that the SOC of battery 8 is the Limit1 or more (when the determination in S1 is NO), the engine control device 11 reads the phase angles of the intake/exhaust valves 24 and 25 detected from the intake valve sensor 39 and the exhaust valve sensor 40 (S8).

Further, the engine control device 11 reads the temperature in the intake manifold 33 by the temperature and pressure sensor 34 in the processing of S8. Then, the engine control device 11 estimates a temperature in the cylinder 21 at a compression top dead center.

Next, the engine control device 11 performs catalyst temperature rise control based on the phase angles of the intake/exhaust valves 24 and 25 and the temperature inside the cylinder 21 at the compression top dead center (S9). This catalyst temperature rise control will be described in detail below.

After that, the engine control device 11 performs motoring (S10). Here, the motoring is to rotate the crankshaft 23 (output shaft) by the electric power of the battery 8 without combustion. After the processing of S10, the engine control device 11 shifts the processing to S5.

### [Catalyst Temperature Rise Control]

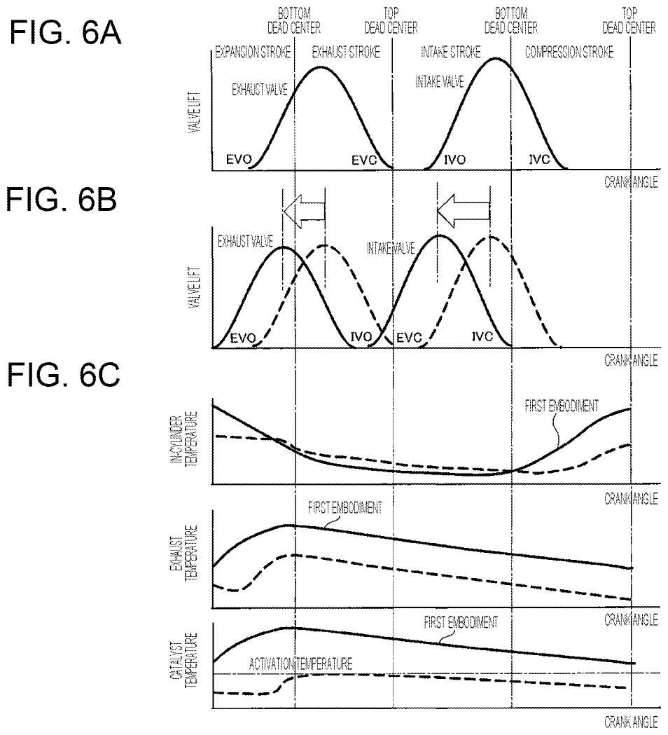

Next, the catalyst temperature rise control performed in S9 of the activation temperature processing of the catalyst illustrated in FIG. 5 will be described with reference to FIG. 6.

FIG. 6 is a diagram illustrating a change in a state quantity of the internal combustion engine due to a catalyst temperature rise control according to the first embodiment.

An Exhaust Valve Open (EVO) illustrated in FIG. 6 indicates an exhaust valve opening timing, and an Exhaust Valve Close (EVC) indicates an exhaust valve closing timing. Further, an Intake Valve Open (IVO) illustrated in FIG. 6 indicates an intake valve opening timing, and an Intake Valve Close (IVC) indicates an intake valve closing timing.

FIG. 6(a) illustrates a valve timing when the catalyst temperature rise control of the engine 2 is not performed in the first embodiment. Further, FIG. 6(b) illustrates a valve timing when the catalyst temperature rise control according to the first embodiment is performed.

In the catalyst temperature rise control according to the first embodiment, an effective compression ratio is increased by the variable valve mechanism. That is, in the catalyst temperature rise control according to the first embodiment, the phases of the intake valve 24 and the exhaust valve 25 are operated using the variable phase type variable valve mechanism and changed from a valve opening/closing profile illustrated in FIG. 6(a) to a valve opening/closing profile illustrated in FIG. 6(b). Specifically, the EVO is brought closer the compression top dead center and the IVC is brought closer to a bottom dead center.

FIG. 6(c) illustrates a temperature inside the cylinder (hereinafter, referred to as an in-cylinder temperature), a temperature of the exhaust gas detected by the temperature and pressure sensor 43 (hereinafter, referred to as an exhaust temperature), and the temperature of the three-way catalyst 45 (hereinafter, referred to as a catalyst temperature) when the catalyst temperature rise control of the first embodiment is performed or not performed for a plurality of cycles.

The in-cylinder temperature begins to decrease as the piston 22 descends, and when the exhaust valve 25 opens (EVO), heat energy held by the gas in the cylinder 21 flows into the exhaust flow path, and thus, the in-cylinder temperature further decreases. At this time, as the EVO is brought closer to the compression top dead center, more heat energy when the air is compressed at the compression top dead center can be guided to the exhaust flow path. Therefore, when the catalyst temperature rise control is performed and the EVO is brought closer to the compression top dead center, the catalyst temperature can increase compared with a case where the catalyst temperature rise control is not performed.

Further, by bringing the IVC closer to the bottom dead center, the effective compression ratio of the engine 2 increases, and the in-cylinder temperature at the top dead center of the compression stroke increases. As a result, the exhaust temperature in the next cycle increases and the catalyst temperature increases. Therefore, when the catalyst temperature rise control is performed and the IVC is brought closer to the bottom dead center, it is possible to increase the catalyst temperature as compared with the case where the catalyst temperature rise control is not performed.

By performing the catalyst temperature rise control for a plurality of cycles, it is possible to warm up (heat) the three-way catalyst 45 without injecting the fuel by the fuel injection device 36 to combust the gas flowing into the cylinder 21 or using a heater. As a result, it is possible to maintain the catalyst temperature above the activation temperature while effectively suppressing deterioration of the exhaust gas.

In the catalyst temperature rise control according to the present embodiment, the EVO is brought closer to the compression top dead center and the IVC is brought closer to the bottom dead center. However, as the catalyst temperature rise control according to the present invention, the EVO may only be brought close to the compression top dead center, or the IVC may only be brought close to the bottom dead center.

### 2. Second Embodiment [Catalyst Temperature Rise Control]

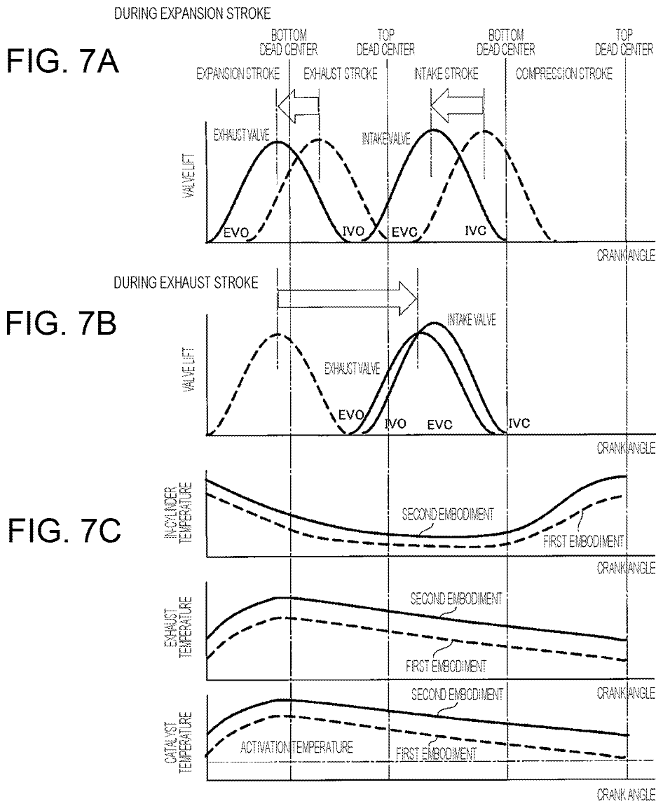

Hereinafter, an internal combustion engine control device according to a second embodiment of the present invention will be described with reference to FIG. 7.

FIG. 7 is a diagram illustrating a change in a state quantity of the internal combustion engine due to a catalyst temperature rise control according to the second embodiment.

The internal combustion engine control device according to the second embodiment has the same configuration as the internal combustion engine control device according to the first embodiment described above, and a difference therebetween is the catalyst temperature rise control. Therefore, here, the catalyst temperature rise control according to the second embodiment will be described, and descriptions of configurations and processing common to the first embodiment will be omitted.

FIG. 7(a) illustrates a valve timing during the expansion stroke in the catalyst temperature rise control of the engine 2 according to the first embodiment. Further, FIG. 7(b) illustrates a valve timing during the exhaust stroke in the catalyst temperature rise control.

In the catalyst temperature rise control according to the second embodiment, the variable valve mechanism is used during the exhaust stroke to perform the EVO in a latter half (late stage) of the exhaust stroke or a first half (early stage) of the intake stroke. At this time, a valve timing of the intake valve 24 may or may not be changed.

FIG. 7(c) illustrates the in-cylinder temperature, the exhaust temperature, and the catalyst temperature when the catalyst temperature rise control of the second embodiment is performed for a plurality of cycles and when the catalyst temperature rise control of the first embodiment is performed for a plurality of cycles.

As illustrated in FIG. 7(b), according to the catalyst temperature rise control of the second embodiment, the exhaust valve 25 is opened during the intake stroke, and thus, the gas flows into the cylinder 21 from the intake pipe 27, the gas from the exhaust pipe 28 re-inflows into the cylinder 21. Since the temperature of the gas (exhaust gas) in the exhaust pipe 28 is increased by the catalyst temperature rise control, the in-cylinder temperature increases as compared with the case where the gas flows in only from the intake pipe 27. That is, the in-cylinder temperature at the time of the IVC increases as compared with that of the first embodiment.

As a result, the in-cylinder temperature in the compression stroke increases, the exhaust temperature becomes higher than that in the first embodiment, and the heat is supplied to the three-way catalyst 45. Therefore, it is possible to maintain the catalyst temperature higher than that of the first embodiment while effectively suppressing the deterioration of the exhaust gas. In the catalyst temperature rise control of the second embodiment, it is possible to surely increase the catalyst temperature to a temperature higher than the catalyst activation temperature even when the outside air temperature is low, and effects of increasing the catalyst temperature during one cycle are enhanced.

The catalyst temperature rise control of the second embodiment may be performed in one specific cylinder or may be performed in a plurality of cylinders. Further, in the second embodiment, the variable valve mechanism is used during the exhaust stroke to move (change) an opening/closing timing of the exhaust valve 25. However, as the catalyst temperature rise control according to the present invention, the opening/closing timing of the exhaust valve 25 may be shifted other than the exhaust stroke, considering an interference between the intake/exhaust valves 24 and 25 and the piston 22.

### 3. Third Embodiment [Catalyst Temperature Rise Control]

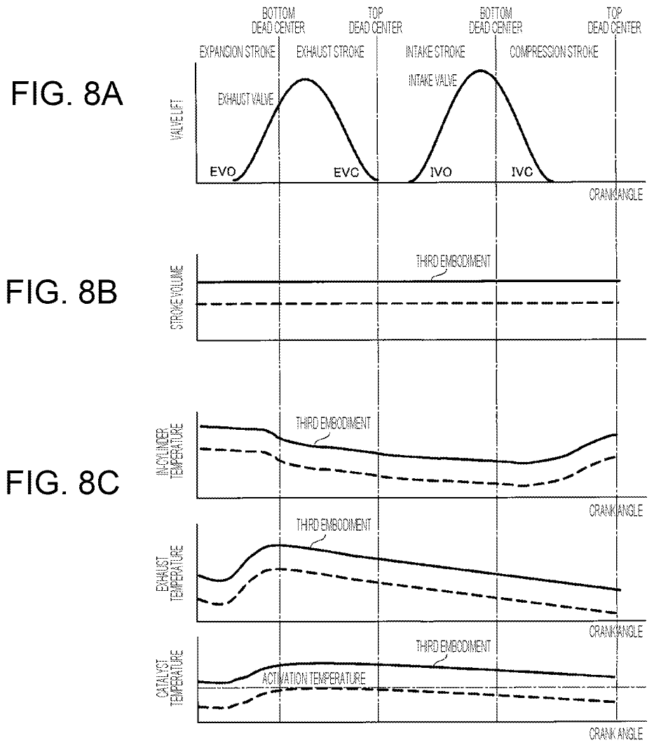

Hereinafter, an internal combustion engine control device according to a third embodiment of the present invention will be described with reference to FIG. 8.

FIG. 8 is a diagram illustrating a change in a state quantity of the internal combustion engine due to a catalyst temperature rise control according to the third embodiment.

The internal combustion engine control device according to the third embodiment has the same configuration as the internal combustion engine control device according to the first embodiment described above, and a difference therebetween is the catalyst temperature rise control. Therefore, here, the catalyst temperature rise control according to the third embodiment will be described, and descriptions of configurations and processing common to the first embodiment will be omitted.

The internal combustion engine control device according to the third embodiment includes a stroke volume variable mechanism capable of changing a stroke volume. The stroke volume is a volume discharged in a stroke in which the piston 22 moves from the bottom dead center to the top dead center. As the stroke volume variable mechanism, for example, a mechanism for changing a piston offset amount or a mechanism for changing a connecting rod length can be applied. Further, a portion in the CPU of the engine control device 11 that controls the stroke volume variable mechanism is a second specific example of the control unit according to the present invention.

FIG. 8(a) illustrates the valve timing when the catalyst temperature rise control of the engine 2 is not performed in the first embodiment. FIG. 7(b) illustrates a stroke volume when the catalyst temperature rise control of the third embodiment is performed and a stroke volume when the catalyst temperature rise control is not performed.

The catalyst temperature rise control according to the third embodiment controls the stroke volume variable mechanism to increase the stroke volume of the cylinder 21. That is, the catalyst temperature rise control according to the third embodiment increases the stroke volume as compared with the case where the catalyst temperature rise control is not performed.

FIG. 7(c) illustrates the in-cylinder temperature, the exhaust temperature, and the catalyst temperature when the catalyst temperature rise control according to the third embodiment is performed for a plurality of cycles and when the catalyst temperature rise control is not performed. When the catalyst temperature rise control according to the third embodiment is performed, the stroke volume increases and a mechanical compression ratio increases. Therefore, the in-cylinder temperature at the compression top dead center increases, and thus, the exhaust temperature in the EVO increases. As a result, it is possible to increase the catalyst temperature as compared with the case where the catalyst temperature rise control is not performed.

By performing the catalyst temperature rise control for a plurality of cycles, it is possible to warm up (heat) the three-way catalyst 45 without injecting the fuel by the fuel injection device 36 to combust the gas flowing into the cylinder 21 or using a heater. As a result, it is possible to maintain the catalyst temperature above the activation temperature while effectively suppressing deterioration of the exhaust gas.

Further, in the catalyst temperature rise control according to the third embodiment, even when the internal combustion engine does not have the variable valve mechanism, it is possible to warm up (heat) the three-way catalyst 45 without injecting a fuel or using a heater.

### 4. Fourth Embodiment [Catalyst Temperature Rise Control]

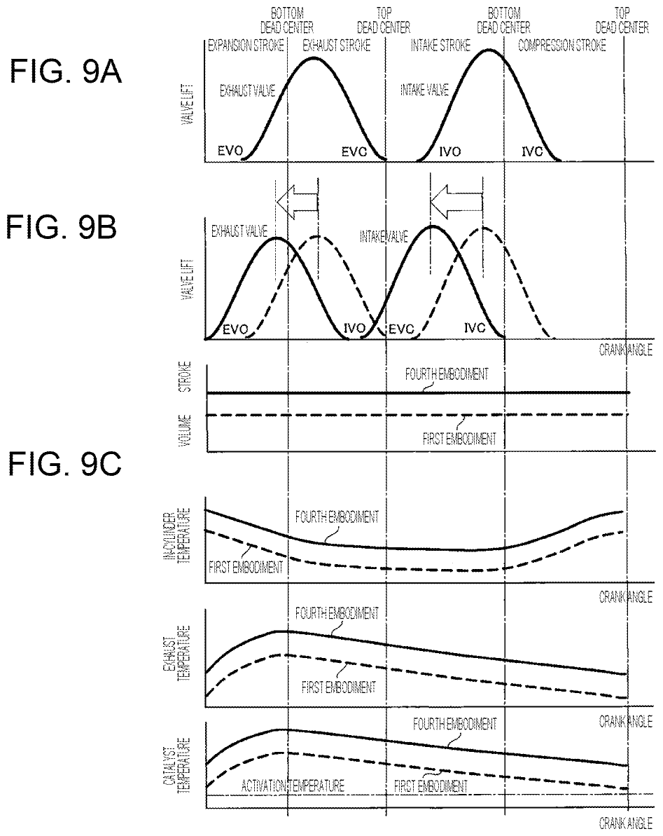

Hereinafter, an internal combustion engine control device according to a fourth embodiment of the present invention will be described with reference to FIG. 9.

FIG. 9 is a diagram illustrating a change in a state quantity of the internal combustion engine due to a catalyst temperature rise control according to the fourth embodiment.

The internal combustion engine control device according to the fourth embodiment has the same configuration as the internal combustion engine control device according to the first embodiment described above, and a difference therebetween is the catalyst temperature rise control. Therefore, here, the catalyst temperature rise control according to the third embodiment will be described, and descriptions of configurations and processing common to the first embodiment will be omitted.

The internal combustion engine control device according to the fourth embodiment includes the variable valve mechanism similarly to the internal combustion engine control device according to the first embodiment. Further, the internal combustion engine control device according to the fourth embodiment includes the stroke volume variable mechanism capable of changing the stroke volume, similarly to the internal combustion engine control device according to the third embodiment.

FIG. 9(a) illustrates the valve timing when the catalyst temperature rise control of the engine 2 is not performed in the first embodiment. FIG. 9(b) illustrates the valve timing and stroke volume when the catalyst temperature rise control of the fourth embodiment is performed.

As illustrated in FIG. 9(b), the catalyst temperature rise control according to the fourth embodiment controls the stroke volume variable mechanism to increase the stroke volume of the cylinder 21 similarly to the third embodiment. Further, the catalyst temperature rise control according to the fourth embodiment operates the phases of the intake valve 24 and the exhaust valve 25 to bring the EVO closer to the compression top dead center and bring the IVC closer to the bottom dead center, similarly to the first embodiment.

FIG. 9(c) illustrates the in-cylinder temperature, the exhaust temperature, and the catalyst temperature when the catalyst temperature rise control according to the fourth embodiment is performed for a plurality of cycles and when the catalyst temperature rise control according to the first embodiment is performed for a plurality of cycles.

When the catalyst temperature rise control according to the fourth embodiment is performed, the stroke volume increases and the mechanical compression ratio increases. Furthermore, by bringing the IVC closer to bottom dead center, the effective compression ratio of the engine 2 increases. As a result, the in-cylinder temperature at the compression top dead center increases as compared with the catalyst temperature rise control according to the first embodiment. Therefore, the exhaust temperature in the EVO increases, and the catalyst temperature can increase earlier as compared with when the catalyst temperature rise control according to the first embodiment is performed.

Further, when the catalyst temperature rise control according to the fourth embodiment is performed, by bringing the EVO closer to the compression top dead center, more heat energy when the air is compressed at the compression top dead center can be guided to the exhaust flow path. Therefore, when the catalyst temperature rise control according to the fourth embodiment is performed, the catalyst temperature can increase earlier as compared with when the catalyst temperature rise control according to the first embodiment is performed.

### 5. Summary

As described above, the internal combustion engine control device (engine control device 11) according to the first to fourth embodiments described above controls the internal combustion engine (engine 2) for the hybrid vehicle (vehicle 1). The internal combustion engine has the catalyst (three-way catalyst 45) that purifies harmful substances in the exhaust gas. Then, the internal combustion engine control device includes the catalyst temperature detection unit (catalyst temperature estimation calculation unit 18) that detects the temperature of the catalyst, and a control unit that performs a catalyst temperature rise control for increasing the temperature of the catalyst and performs motoring when the temperature of the catalyst detected by the catalyst temperature detection unit does not reach the predetermined temperature. As a result, it is possible to warm up (heat) the catalyst without combusting the gas or using the heater. As a result, it is possible to maintain the catalyst temperature above the activation temperature while effectively suppressing deterioration of the exhaust gas.

In the invention described in PTL 1, even when the motoring operation of the engine is controlled without providing the heater on the upstream side of the catalyst, it is difficult to generate enough exhaust heat and exhaust enthalpy to warm up the catalyst.

Further, in the catalyst temperature rise control according to the first to fourth embodiments described above, at least one of the control for increasing the effective compression ratio of the internal combustion engine or the control for increasing the mechanical compression ratio is performed to increase the exhaust temperature of the internal combustion engine. As a result, when at least one of the mechanism for increasing the effective compression ratio of the internal combustion engine or the mechanism for increasing the mechanical compression ratio is provided, it is possible to warm up (heat) the catalyst without combusting a gas or using a heater.

Further, the catalyst temperature rise control according to the first, second, and fourth embodiments described above is a control that brings the opening timing of the exhaust valve (exhaust valve 25) closer to the top dead center by the variable valve mechanism. Accordingly, more heat energy when air is compressed at the top dead center can be guided to the exhaust flow path, and the catalyst temperature can increase.

Further, the catalyst temperature rise control according to the first, second, and fourth embodiments described above is a control that brings the closing timing of the intake valve (intake valve 24) closer to the bottom dead center by the variable valve mechanism. Accordingly, the effective compression ratio of the internal combustion engine increases, and the in-cylinder temperature at the top dead center of the compression stroke can increase. As a result, the temperature of the exhaust gas (exhaust temperature) in the next cycle increases, and the catalyst temperature can increase.

Further, the catalyst temperature rise control according to the third and fourth embodiments described above is a control that increases the stroke volume of the internal combustion engine by the stroke volume variable mechanism. Accordingly, the mechanical compression ratio of the internal combustion engine increases, the in-cylinder temperature at the compression top dead center increases, and thus, the temperature (exhaust temperature) of the exhaust gas at the opening timing of the exhaust valve (exhaust valve 25) can increase. As a result, the catalyst temperature can increase.

Further, the catalyst temperature rise control according to the second embodiment described above is a control that causes a gas to flow from the intake valve (intake valve 24) and the exhaust valve (exhaust valve 25) into the cylinder (cylinder 21). Accordingly, the gas (exhaust gas) whose temperature has increased in the exhaust pipe (exhaust pipe 28) also flows into the cylinder, and thus, the temperature inside the cylinder (in-cylinder temperature) can increase as compared with the case where the gas flows in only from the intake pipe (intake pipe 27).

Further, in the internal combustion engine control device according to the first to fourth embodiments described above, the catalyst temperature estimation calculation unit 18 is applied as the catalyst temperature detection unit. Then, the catalyst temperature estimation calculation unit 18 calculates the estimated temperature of the catalyst (three-way catalyst 45) using the temperature of the cooling water that cools the cylinder (cylinder 21). Accordingly, the temperature of the catalyst can be detected without providing a special sensor or the like, and the number of parts can be reduced.

Further, the control unit (CPU) of the internal combustion engine control device according to the first to fourth embodiments described above stops the catalyst temperature rise control when the remaining capacity of the battery is smaller than the first threshold (Limit3). Accordingly, the internal combustion engine (engine 2) can be used as a power source when the remaining capacity of the battery is smaller than the first threshold (Limit3).

Further, the control unit (CPU) of the internal combustion engine control device according to the first to fourth embodiments described above performs the catalyst temperature rise control when the remaining capacity of the battery is the first threshold (Limit3) or more and smaller than the second threshold (Limit2), or when the remaining capacity of the battery is larger than the third threshold (Limit1) which is a value larger than the second threshold. When the remaining capacity of the battery is the first threshold or more and smaller than the second threshold, the catalyst can be warmed up (heated) in preparation for switching the power source to the internal combustion engine (engine 2). Moreover, when the remaining capacity of the battery is larger than the third threshold, it is determined that there is surplus power, and the catalyst can be warmed up (heated) with the surplus power.

Further, the control unit (CPU) of the internal combustion engine control device according to the first to fourth embodiments described above determines whether or not the fuel injection by the fuel injection device 36 is stopped, and when it is determined that the fuel injection is stopped, the control unit performs the catalyst temperature rise control. As a result, it is possible to prevent the catalyst temperature rise control from being performed when the fuel injection by the fuel injection device 36 is performed.

Heretofore, the embodiments of the internal combustion engine control device of the present invention have been described, including the operational effects. However, the internal combustion engine control device of the present invention is not limited to the above-described embodiments, and various modifications can be made without departing from the gist of the invention described in claims.

For example, the embodiments are described in detail for the purpose of clearly explaining the present invention, and is not necessarily limited to those including all the configurations described. Further, it is possible to replace a portion of the configuration of one embodiment with the configuration of another embodiment, and it is also possible to add the configuration of another embodiment to the configuration of one embodiment. Further, it is possible to perform addition/deletion/replacement on other configurations with respect to a portion of the configurations of each embodiment.

For example, in the first to fourth embodiments described above, the catalyst temperature rise control according to the present invention is applied to the so-called series type vehicle 1 in which the engine 2 is used as a power source for power generation. However, the catalyst temperature rise control according to the present invention is not limited to being applied to the series type vehicle, and for example, can be applied to a so-called parallel type vehicle in which a plurality of mounted power sources (motor and engine) are used to drive wheels. Further, the catalyst temperature rise control according to the present invention can also be applied to a so-called series parallel (split) type vehicle in which torque from an engine is divided by a power split mechanism and distributed to a generator and a drive shaft.

Further, in the first to fourth embodiments described above, the three-way catalyst 45 is applied as the catalyst. However, the catalyst according to the present invention is not limited to the three-way catalyst, and for example, a NOx storage reduction catalyst can be applied.

### REFERENCE SIGNS LIST

1 vehicle
2 engine
3 motor
4 shaft
5 tire
6 generator
7 inverter
8 battery
10 vehicle control system
11 engine control device (internal combustion engine control device)
12 battery control device
13 electric motor control device
14 integrated control device
18 catalyst temperature estimation calculation unit
21 cylinder
22 piston
23 crankshaft
24 intake valve
25 exhaust valve
27 intake pipe
28 exhaust pipe
31 throttle valve
32 airflow sensor
33 intake manifold
34, 43 temperature and pressure sensor
36 fuel injection device
37 spark plug
38 water temperature sensor
39 intake valve sensor
40 exhaust valve sensor
41 connecting rod
42 crank angle sensor
44 air-fuel ratio sensor
45 three-way catalyst

1. An internal combustion engine control device that controls an internal combustion engine for a hybrid vehicle, in which the internal combustion engine has a catalyst that purifies harmful substances in an exhaust gas,
the internal combustion engine control device comprising:
a catalyst temperature detection unit that detects a temperature of the catalyst; and
a control unit that performs a catalyst temperature rise control for increasing the temperature of the catalyst and performs motoring when the temperature of the catalyst detected by the catalyst temperature detection unit does not reach a predetermined temperature.

2. The internal combustion engine control device according to claim 1, wherein in the catalyst temperature rise control, at least one of a control for increasing an effective compression ratio of the internal combustion engine or a control for increasing a mechanical compression ratio is performed to increase an exhaust temperature of the internal combustion engine.

3. The internal combustion engine control device according to claim 2, wherein
the internal combustion engine has a variable valve mechanism that changes an opening/closing timing of an exhaust valve, and
the catalyst temperature rise control is a control that brings the opening timing of the exhaust valve closer to a top dead center.

4. The internal combustion engine control device according to claim 2, wherein
the internal combustion engine has a variable valve mechanism that changes an opening/closing timing of an intake valve, and
the catalyst temperature rise control is a control that brings the closing timing of the intake valve closer to a bottom dead center.

5. The internal combustion engine control device according to claim 2, further comprising:
a stroke volume variable mechanism capable of changing a stroke volume of the internal combustion engine,
wherein the catalyst temperature rise control is a control that increases the stroke volume of the internal combustion engine by the stroke volume variable mechanism.

6. The internal combustion engine control device according to claim 1, wherein the catalyst temperature rise control is a control that causes a gas to flow from an intake valve and an exhaust valve of the internal combustion engine into a cylinder.

7. The internal combustion engine control device according to claim 1, wherein the catalyst temperature detection unit calculates an estimated temperature of the catalyst using a temperature of cooling water that cools a cylinder of the internal combustion engine.

8. The internal combustion engine control device according to claim 1, wherein the control unit stops the catalyst temperature rise control when a remaining capacity of a battery is smaller than a first threshold.

9. The internal combustion engine control device according to claim 8, wherein the control unit performs the catalyst temperature rise control when the remaining capacity of the battery is the first threshold or more and smaller than a second threshold, or when the remaining capacity of the battery is larger than a third threshold which is a value larger than the second threshold regardless of the temperature of the catalyst.

10. The internal combustion engine control device according to claim 1, wherein the control unit determines whether or not fuel injection of the internal combustion engine is stopped, and when it is determined that the fuel injection is stopped, the control unit performs the catalyst temperature rise control.

11. An internal combustion engine control device that controls an internal combustion engine for a hybrid vehicle, in which the internal combustion engine has a catalyst that purifies harmful substances in an exhaust gas,
the internal combustion engine control device comprising:
a catalyst temperature detection unit that detects a temperature of the catalyst; and
a control unit that performs a control for increasing an effective compression ratio of the internal combustion engine or a control for increasing a mechanical compression ratio and performs motoring when the temperature of the catalyst detected by the catalyst temperature detection unit does not reach a predetermined temperature.

12. The internal combustion engine control device according to claim 10, wherein when the temperature of the catalyst detected by the catalyst temperature detection unit does not reach the predetermined temperature, the control unit performs a control for causing a gas to flow from an intake valve and an exhaust valve of the internal combustion engine into a cylinder in addition to a control for increasing an effective compression ratio of the internal combustion engine or a control for increasing a mechanical compression ratio.

13. An internal combustion engine control device that controls an internal combustion engine for a hybrid vehicle, in which the internal combustion engine has a catalyst that purifies harmful substances in an exhaust gas,
the internal combustion engine control device comprising:
a catalyst temperature detection unit that detects a temperature of the catalyst; and
a control unit that performs a control for causing a gas to flow from an intake valve and an exhaust valve of the internal combustion engine into a cylinder and performs motoring when the temperature of the catalyst detected by the catalyst temperature detection unit does not reach a predetermined temperature.
